(19) United States
(12) Patent Application Publication
(10) Pub. No.: US 2026/0248294 A1
(43) Pub. Date: Aug. 27, 2026

(54) CONTROL APPARATUS AND BED

(71) Applicant: PARAMOUNT BED CO., LTD., Tokyo (JP)

(72) Inventors: Masakazu HARADA, Koto-ku (JP); Makoto TANAKA, Koto-ku (JP)

(73) Assignee: PARAMOUNT BED CO., LTD., Tokyo (JP)

(21) Appl. No.: 19/411,775

(22) Filed: Dec. 8, 2025

(30) Foreign Application Priority Data
Feb. 21, 2025 (JP) 2025-027193

(51) Int. Cl. A47C 21/04; A61G 7/057

(52) U.S. Cl. CPC A47C 21/044; A61G 7/05784; A61G 2203/44

(57) ABSTRACT

A control apparatus is for controlling an airflow rate of an air blowing apparatus configured to send air into an air blowing sheet including a cover and a diffusion layer. The cover has waterproofness and moisture permeability. The diffusion layer is provided inside the cover and has air permeability. The control apparatus includes a processor configured to control the airflow rate of the air blowing apparatus based on information on a temperature and a humidity between a user and the air blowing sheet.

### CROSS-REFERENCE TO RELATED APPLICATIONS

This application is based upon and claims the benefit of priority from the prior Japanese Patent Application No.2025-027193, filed on February 21, 2025; the entire contents of which are incorporated herein by reference.

### FIELD

An embodiment of the present disclosure relates to a control apparatus and a bed.

### BACKGROUND

A sheet of a control apparatus is provided between a mattress of a bed, and a user. Air is blown to the sheet. The amount of air to be blown is controlled in accordance with a state of the user. Suitable control is desired in the control apparatus.

### BRIEF DESCRIPTION OF THE DRAWINGS

FIG. 1 is a block diagram illustrating an example of a control apparatus according to an embodiment.

FIG. 2 is a schematic perspective view illustrating an example of the control apparatus according to the embodiment.

FIG. 3 is a diagram illustrating an example of an air flow rate control table in a processor of the control apparatus according to the embodiment.

FIG. 4 is a diagram illustrating an example of an air flow rate control table in the processor of the control apparatus according to the embodiment.

FIG. 5 is a diagram illustrating an example of an air flow rate control table in the processor of the control apparatus according to the embodiment.

FIG. 6 is a block diagram illustrating an example of a part of a bed according to the embodiment.

FIG. 7 is a schematic perspective view illustrating an example of a part of the bed according to the embodiment.

FIG. 8 is a schematic cross-sectional view illustrating an example of a part of the bed according to the embodiment.

FIG. 9 is a schematic side view illustrating an example of a part of the bed according to the embodiment.

FIG. 10 is a schematic plan view illustrating an example of a part of the bed according to the embodiment.

### DETAILED DESCRIPTION

One or more embodiments are now described with reference to the drawings, wherein like reference numerals are used to refer to like elements throughout. In the following description, for purposes of explanation, numerous specific details are set forth in order to provide a thorough understanding of the various embodiments. It is evident, however, that the various embodiments can be practiced without these specific details (and without applying to any particular networked environment or standard).

As used in this disclosure, in some embodiments, the terms "component," "system" and the like are intended to refer to, or comprise, a computer-related entity or an entity related to an operational apparatus with one or more specific functionalities, wherein the entity can be either hardware, or a combination of hardware and software in execution.

One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software stored on a non-transitory electronic memory or firmware that confers at least in part the functionality of the electronic components. While various components have been illustrated as separate components, it will be appreciated that multiple components can be implemented as a single component, or a single component can be implemented as multiple components, without departing from example embodiments. Further, the various embodiments can be implemented as a method, apparatus or article of manufacture using standard programming and/or engineering techniques to produce software, firmware, hardware or any combination thereof to control a computer to implement the disclosed subject matter. The term "article of manufacture" as used herein is intended to encompass a computer-readable (or machine-readable) device or computer-readable (or machine-readable) storage/communications media having a computer program stored thereon. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words "example" and "exemplary" are used herein to mean serving as an instance or illustration. Any embodiment or design described herein as "example" or "exemplary" is not necessarily to be construed as preferred or advantageous over other embodiments or designs. Rather, use of the word example or exemplary is intended to present concepts in a concrete fashion. As used in this application, the term "or" is intended to mean an inclusive "or" rather than an exclusive "or". That is, unless specified otherwise or clear from context, "X employs A or B" is intended to mean any of the natural inclusive permutations. That is, if X employs A; X employs B; or X employs both A and B, then "X employs A or B" is satisfied under any of the foregoing instances. In addition, the articles "a" and "an" as used in this application and the appended claims should generally be construed to mean "one or more" unless specified otherwise or clear from context to be directed to a singular form.

Embodiments described herein can be exploited in substantially any wireless communication technology, comprising, but not limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra mobile broadband (UMB), high speed packet access (HSPA), Z-Wave, Zigbee and other 802.XX wireless technologies and/or legacy telecommunication technologies.

In general, one aspect of the present application is a control apparatus for controlling an air flow rate of an air blowing apparatus configured to send air into an air blowing sheet including a cover and a diffusion layer, the cover having waterproofness and moisture permeability, the diffusion layer being provided inside the cover and having air permeability, the control apparatus including:

a processor configured to control the air flow rate of the air blowing apparatus based on information on a temperature and a humidity between a user and the air blowing sheet.

Another aspect of the present application is a bed including:

an air blowing sheet including a cover having waterproofness and moisture permeability, and a diffusion layer provided inside the cover and having air permeability;

a mattress that is provided below the air blowing sheet;

a control apparatus including a processor configured to control an air flow rate; and

an air blowing apparatus configured to send air having an air flow rate controlled by the control apparatus into the air blowing sheet, in which

the control apparatus is configured to control the air flow rate of the air blowing apparatus based on information on a temperature and a humidity between a user and the air blowing sheet.

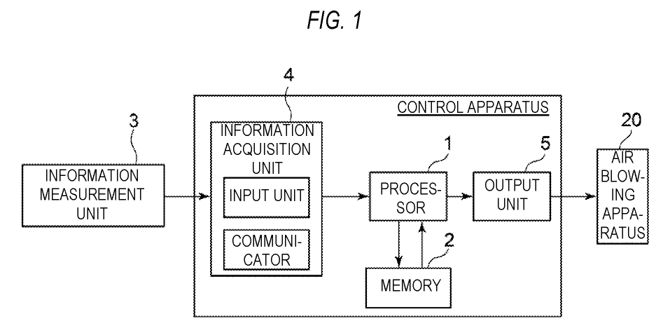

FIG. 1 is a block diagram illustrating an example of a control apparatus according to an embodiment.

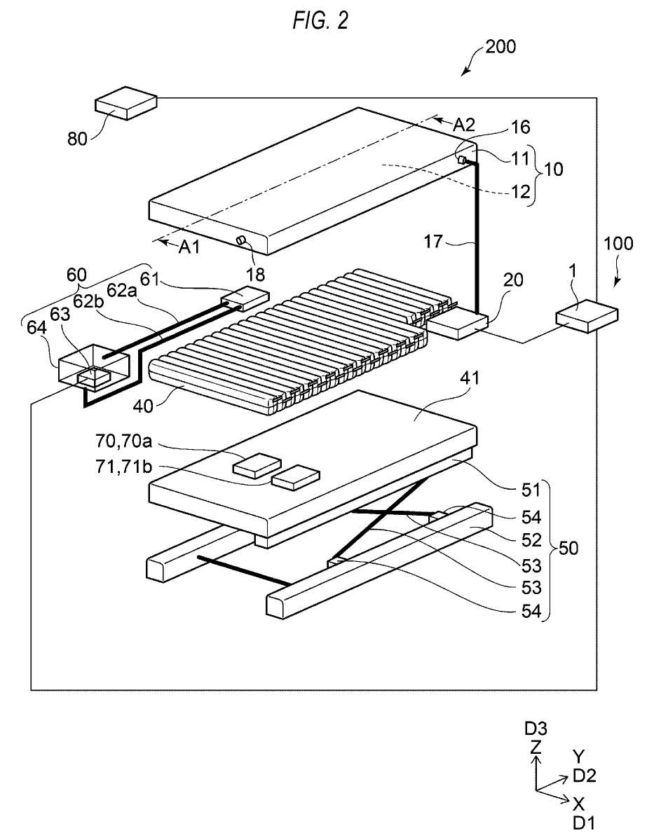

FIG. 2 is a schematic perspective view illustrating an example of the control apparatus according to the embodiment.

As illustrated in FIGS. 1 and 2, a control apparatus 100 according to the embodiment controls the air flow rate of an air blowing apparatus 20 that sends the air into an air blowing sheet 10. The control apparatus 100 includes a processor 1.

The air blowing sheet 10 includes a cover 11 and a diffusion layer 12. The cover 11 has waterproofness and moisture permeability. The diffusion layer 12 is provided in the cover 11. The diffusion layer 12 has air permeability.

The processor 1 controls the air flow rate of the air blowing apparatus 20 based on information on a temperature and a humidity between a user and the air blowing sheet 10.

The control apparatus 100, which includes the processor 1, can control the air flow rate of the air blowing apparatus 20 based on information on a temperature and a humidity between a user and the air blowing sheet 10. This allows suitable control.

The air blowing sheet 10 may include an air blowing port 16 and an air-exhaust port 18. The air is blown into the air blowing port 16 from the air blowing apparatus 20. The blown air is discharged from the air blowing sheet 10 through the air-exhaust port 18. The processor 1 may control the air flow rate of the air blowing apparatus 20 based on information on the amount of air blown into the air blowing port 16 and the amount of air discharged from the air-exhaust port 18.

The processor 1 may control the air flow rate of the air blowing apparatus 20 based on information on a state of strain with respect to the diffusion layer 12 by a user. The state of strain with respect to the diffusion layer 12 has an influence on urethane to be used as a material, so that an air flow rate control table in which compression of the diffusion layer 12 is considered from a type of the urethane and a body weight of the user is stored in a memory 2 (first memory), and the processor 1 controls the air flow rate based on the air flow rate control table. A sensor or the like that detects a degree to which the diffusion layer 12 is compressed is provided, and the processor 1 may control the air flow rate in accordance with the compression degree. The compression of the diffusion layer 12 also has an influence on the compression intensity and the hardness of the diffusion layer 12.

The control apparatus 100 may include the memory 2, an information measurement unit 3, an information acquisition unit 4, and an output unit 5. The information acquisition unit 4 includes an input unit and a communicator. The information acquisition unit 4 acquires information from the information measurement unit 3. Information such as temperature-humidity and other environmental factor is input from the information acquisition unit 4. The processor 1 receives the information, and outputs the information to the output unit 5. The output unit 5 outputs the information to the air blowing apparatus 20.

In the information acquisition in the information acquisition unit 4, the input unit may acquire the information measured by the information measurement unit 3 with manual input, or the communicator may acquire information from the information measurement unit 3. The information acquisition unit 4 may include a temperature-humidity information acquisition unit, a body weight information acquisition unit, a heart rate information acquisition unit, a sleep depth information acquisition unit, and an illumination information acquisition unit.

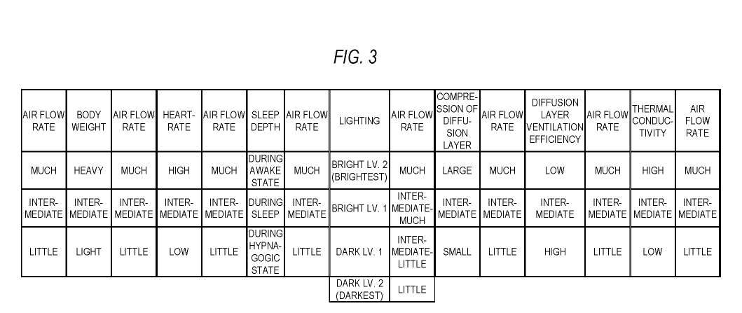

FIGS. 3, 4, and 5 are diagrams illustrating examples of air flow rate control tables in a processor of the control apparatus according to the embodiment.

Parameters may be the temperature and the humidity, the body weight, the heart rate, the sleep depth, the illumination (lighting), the compression of the diffusion layer 12, and the ventilation efficiency and the thermal conductivity of the diffusion layer 12, for example. In the air flow rate control of each parameter, an indicator in the basic control table illustrated in FIG. 3 is used. As one example of the control, for example, the control may be performed for each parameter, but in a case where a plurality of parameters are present, each parameter is weighted, and the processor 1 determines which parameter is weighted and determines an air flow rate level based on the weighting, thereby performing the control. In a case where a plurality of parameters are present, the processor 1 may perform the air flow rate control such that an air flow rate control variable may be set relative to the control for each parameter, and an air flow rate level may be determined based on a result obtained by multiplying the air flow rate control variables. In the air flow rate control of each parameter, an indicator in the basic control table illustrated in FIG. 3 is used.

The processor 1 may control the air flow rate of the air blowing apparatus 20 based on body weight information on the user. The strain becomes more in a case where the body weight of the user is heavy than in a case where the body weight of the user is light. As illustrated in FIG. 3, when the body weight of the user is heavy, the processor 1 increases the air flow rate. When the body weight of the user is light, the processor 1 decreases the air flow rate. The air flow rate when the body weight is heavy is more than the air flow rate when the body weight is light.

The processor 1 may control the air flow rate of the air blowing apparatus 20 based on heart rate information on the user. As illustrated in FIG. 3, when the heart rate is high, the processor 1 increases the air flow rate of the air blowing apparatus 20. When the heart rate is low, the processor 1 decreases the air flow rate of the air blowing apparatus 20. The air flow rate when the heart rate is high is more than the air flow rate when the heart rate is low.

The processor 1 may control the air flow rate of the air blowing apparatus 20 based on information on the depth of sleep of the user. As illustrated in FIG. 3, the types of the depth of sleep may be during an awake state, during sleep, and during a hypnagogic state, for example. When the user is during a hypnagogic state, the processor 1 decreases the air flow rate of the air blowing apparatus 20. When the user is during an awake state, the processor 1 increases the air flow rate of the air blowing apparatus 20. The air flow rate during sleep is weaker than the air flow rate during an awake state and stronger than the air flow rate during a hypnagogic state. The air flow rate when the depth of sleep is deep is less than the air flow rate when the depth of sleep is low.

The processor 1 may control the air flow rate of the air blowing apparatus 20 based on information on the illumination of a room where the user is present. As illustrated in FIG. 3, the air flow rate when the illumination in the room is at a bright level 1 is smaller than the air flow rate when it is at a bright level 2. The air flow rate when the illumination in the room is at a dark level 1 is larger than the air flow rate when it is at a dark level 2.

The processor 1 may control the air flow rate of the air blowing apparatus 20 in accordance with the ventilation efficiency of the diffusion layer 12 (the degree of easiness of the ventilation in the diffusion layer 12). The degree of easiness of the ventilation in the diffusion layer 12 has an influence on the density of a material, such as urethane, which is used for the diffusion layer 12. The processor 1 includes an air flow rate control table in which the ventilation efficiency of the diffusion layer 12 is considered from the type of material, such as urethane, and the body weight of the user, in the memory 2, and controls the air flow rate based on the air flow rate control table. The processor 1 may detect an efficiency of the amount of air blown to the diffusion layer 12 by a sensor or the like, and control the air flow rate of the air blowing apparatus 20 in accordance with the efficiency. The processor 1 may control the air flow rate of the air blowing apparatus 20 in accordance with the density (size of holes) of a material constituting the diffusion layer 12. When the ventilation efficiency of the diffusion layer 12 is low, the processor 1 increases the air flow rate. When the ventilation efficiency of the diffusion layer 12 is high, the processor 1 decreases the air flow rate. The air flow rate when the ventilation efficiency is low is more than the air flow rate when the ventilation efficiency is high.

The processor 1 may control the air flow rate of the air blowing apparatus 20 in accordance with the thermal conductivity of the diffusion layer 12 and the cover 11. The processor 1 may control the air flow rate based on the actual measurement value of the temperature-humidity, and the thermal conductivity of the diffusion layer 12 and the cover 11. When the thermal conductivity is high, the processor 1 increases the air flow rate. When the thermal conductivity is low, the processor 1 decreases the air flow rate. The air flow rate when the thermal conductivity is high is more than the air flow rate when the thermal conductivity is low.

The processor 1 may control the air flow rate of the air blowing apparatus 20 in accordance with the compression of the diffusion layer 12. When the compression of the diffusion layer 12 is large, the processor 1 increases the air flow rate. When the compression of the diffusion layer 12 is small, the processor 1 decreases the air flow rate. The air flow rate when the compression of the diffusion layer 12 is large is more than the air flow rate when the compression of the diffusion layer 12 is small.

The processor 1 may control the air flow rate in accordance with the degree of easiness of a rise in temperature in the diffusion layer 12 and the cover 11. Based on the actual measurement value of the temperature-humidity and the specific heat of the diffusion layer 12 and the cover 11, the processor 1 may control the air flow rate in which those are considered.

The processor 1 may control the air flow rate of the air blowing apparatus 20 based on complex information in which information on the temperature and the humidity is combined with at least one piece of information selected from information on the body weight of the user, information on the heart rate of the user, information on the depth of sleep of the user, information on the illumination in the room where the user is present, the ventilation efficiency to the diffusion layer 12, and the compression of the diffusion layer 12. The processor 1 may control the air flow rate of the air blowing apparatus 20 by considering in a complex manner the above-mentioned state of strain, the amount of air blown to the air blowing port 16 and the amount of air discharged from the air-exhaust port, and parameters such as the body weight of the user, the heart rate, the depth, and the illumination. This can efficiently control the temperature-humidity. The memory 2 stores the air flow rate control tables as illustrated in FIGS. 3, 4, and 5.

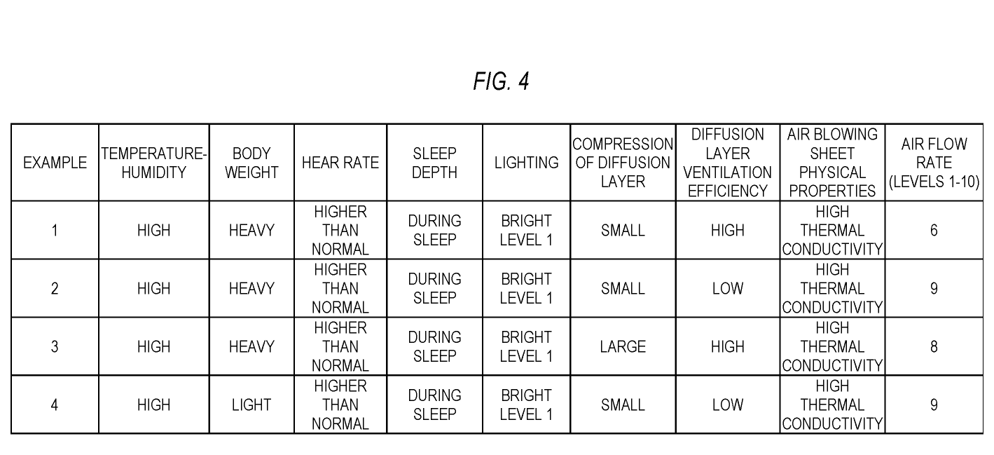

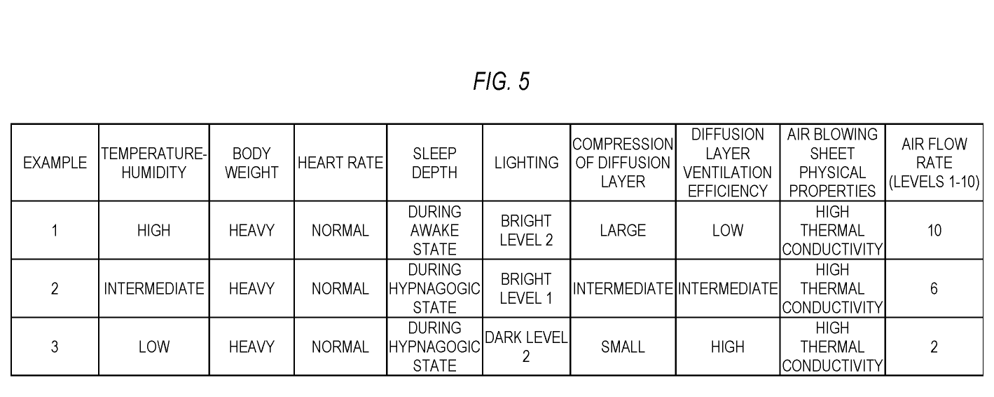

The above-mentioned complex information may include weighting (the degree of importance). The weighting may be assigned such that temperature and humidity are given the highest priority, followed by the ventilation efficiency to the diffusion layer 12, the compression of the diffusion layer 12, body weight, the air blowing sheet 10, heart rate, sleep depth, and finally, illumination in the room. The weighting decreases in the order of the temperature and the humidity, the ventilation efficiency to the diffusion layer 12, the compression of the diffusion layer 12, the body weight, the air blowing sheet 10, the heart rate, the depth of sleep, and the illumination in the room. The air flow rate based on the complex information is divided into levels (indicators) of from 1 to 10 as illustrated in FIGS. 4 and 5, for example.

FIG. 4 illustrates an example in a case where in the air flow rate control based on the complex information, weighting is assigned among the parameters. As illustrated in FIG. 4, when Example 1 is compared with Example 2, only the ventilation efficiency of the diffusion layer 12 is different from each other, and Example 2 has a larger air flow rate level. When Example1 is compared with Example 3, only the compression of the diffusion layer 12 is different from each other, and Example 3 has a larger air flow rate level. When Example 2 is compared with Example3, Example 3 has larger compression of the diffusion layer 12, which does not largely affect the ventilation efficiency of the diffusion layer 12, so that Example 3 has a smaller air flow rate level due to the height of weighting. When Example 2 is compared with Example 4, only the body weight is different from each other, and Example 4 has an air flow rate level 9 similar to Example 2 because the ventilation efficiency of the diffusion layer 12 having high weighting in Example 4 is low similar to Example 2, regardless that the air flow rate level becomes smaller as the body weight is lighter in the viewpoint of the body weight. In the air flow rate level, the air flow rate at the air flow rate level 10 is more than the air flow rate at the air flow rate level 1.

FIG. 5 illustrates an example in a case where in the air flow rate control based on the complex information, an air flow rate control variable is assigned to each parameter. As illustrated in FIG. 5, based on a result obtained by multiplying the air flow rate control variables for the control of the respective parameters in the complex information, the processor 1 determines the air flow rate level, and performs the air flow rate control. For example, when an air flow rate control variable for the temperature and the humidity is set to 100% as a reference in the temperature-humidity, high may be set to 150%, and low may be set to 50%. In this manner, an air flow rate control variable is set to each parameter. The air flow rate control may be performed based on the following Expression.

Air flow rate level = (air flow rate control variable of temperature-humidity) × (air flow rate control variable of body weight) × ... × (air flow rate control variable of air blowing sheet physical properties) × (standard air flow rate level, example: 5)

In the air flow rate control of each parameter, indicators in the basic control tables illustrated in FIGS. 4 and 5 are used. For example, parameters other than the air flow rate control variable of the temperature and the humidity are set as appropriate, the air flow rate level having ten stages can be set by multiplying the variables of the respective parameters. The air flow rate control variable may be set for each parameter, but the embodiment is not limited thereto. For example, based on the air flow rates as follows (MUCH (5), INTERMEDIATE-MUCH (4), INTERMEDIATE (3), INTERMEDIATE-LITTLE (2), LITTLE (1)) indicated by the basic control table illustrated in FIG. 3, these variables may uniformly be set, for example, MUCH (5): 1.1, INTERMEDIATE-MUCH (4): 1.05, INTERMEDIATE (3): 1, INTERMEDIATE-LITTLE (2): 0.95, and LITTLE (1): 0.9.

A bed 200 according to the embodiment will be described hereinafter.

As illustrated in FIG. 2, the bed 200 includes the air blowing sheet 10, a mattress 40, the control apparatus 100, and the air blowing apparatus 20. The air blowing sheet 10 is as described above. The mattress 40 is provided below the air blowing sheet 10. The control apparatus 100 includes the processor 1. The control apparatus 100 and the processor 1 are as described above. The air blowing apparatus 20 sends the air having an air flow rate controlled by the control apparatus 100 into the air blowing sheet 10.

In a case where the processor 1 processes information on the temperature-humidity and the like acquired by the information acquisition unit 4, the control apparatus 100 is provided with the memory 2 including the air flow rate control table related to the information on the temperature-humidity and the like. Based on the air flow rate control table, the processor 1 controls the air blowing flow rate of the air blowing apparatus 20. In the air flow rate control, learning may be performed using a learning model, and the air flow rate may be controlled based on the learning model. As an example of the learning model, for example, in terms of the air flow rate control based on the information on the temperature-humidity and the like to be acquired by the information acquisition unit 4, a user feedback, and a temperature-humidity result after the air blowing are learned. The learning model may rewrite the air flow rate control table stored in the memory 2. The air flow rate of the air blowing apparatus may be controlled using the learning model to calculate an index related to the user's comfort based on the information on the temperature and humidity, or based on the user feedback, and to ensure that the calculated index falls within a predetermined target range.

The bed 200 may be provided with the control apparatus 100. Alternatively, the control apparatus 100 may be positioned so as to be connected to the air blowing apparatus 20. Alternatively, the air blowing apparatus 20 may be provided with the control apparatus 100. The control apparatus 100 may be a server itself, a part of the control apparatus 100 may be implemented as a server, or the processor 1 of an air mattress 40a may also function as the control apparatus 100.

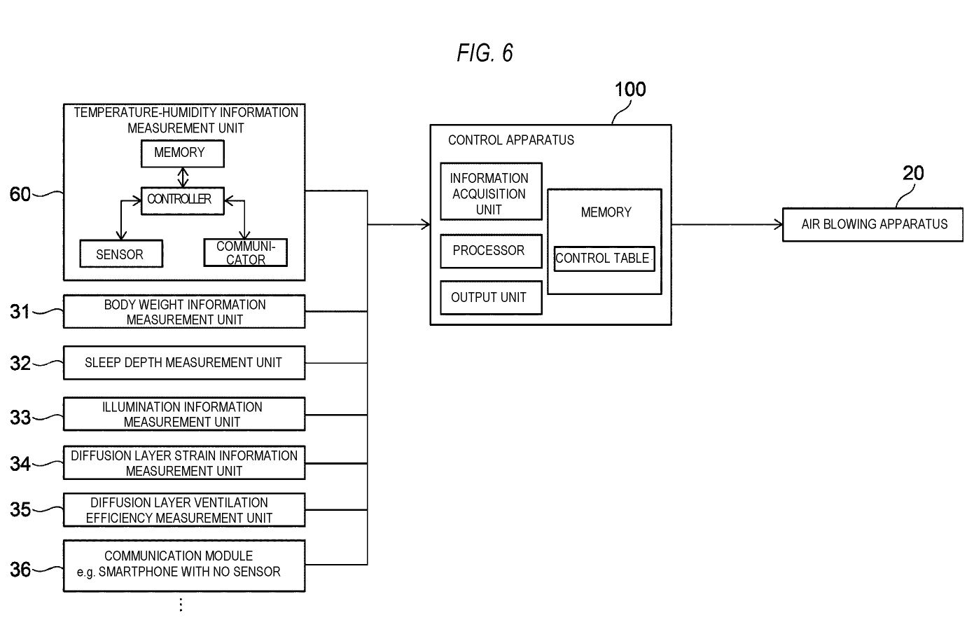

FIG. 6 is a block diagram illustrating an example of a part of a bed according to the embodiment.

As illustrated in FIG. 6, the bed 200 may include a temperature-humidity information measurement unit 60, and the information measurement unit 3 including a body weight information measurement unit 31, a sleep depth measurement unit 32, an illumination information measurement unit 33, a diffusion layer strain information measurement unit 34, a diffusion ventilation efficiency measurement unit 35, a communication module 36, and the like. Each of the temperature-humidity information measurement unit 60, the body weight information measurement unit 31, the sleep depth measurement unit 32, the illumination information measurement unit 33, the diffusion layer strain information measurement unit 34, the diffusion ventilation efficiency measurement unit 35, and the communication module 36 is connected to the control apparatus 100 via the electric communication. For example, the temperature-humidity information measurement unit 60 includes a memory 2 (second memory), a controller, a sensor, and a communicator. The memory 2 is connected to the controller via the electric communication. The sensor is connected to the controller via the electric communication. The communicator is connected to the controller via the electric communication. The communication module 36 can be a smartphone or the like, and with the configuration in which information measured by any of the temperature-humidity information measurement unit 60, the body weight information measurement unit 31, the sleep depth measurement unit 32, the illumination information measurement unit 33, the diffusion layer strain information measurement unit 34, and the diffusion ventilation efficiency measurement unit 35 is transmitted to the communication module 36, the information is indirectly measured.

The temperature-humidity information acquisition unit included in the control apparatus 100 in the bed 200 acquires temperature-humidity information measured by the temperature-humidity information measurement unit 60. The temperature-humidity information measurement unit 60 may be provided below the air blowing sheet 10. The temperature-humidity information measurement unit 60 may be provided between the air blowing sheet 10 and a user. The temperature-humidity information measurement unit 60 measures the temperature and the humidity between the user and the air blowing sheet 10. The processor 1 receives information from the temperature-humidity information acquisition unit, and controls the air flow rate of the air blowing apparatus 20. In a case where the temperature and the humidity in the bed are higher than reference values, for example, the processor 1 increases the air flow rate of the air to be sent to the air blowing sheet 10 by the air blowing apparatus 20. On the other hand, in a case where the temperature and the humidity in the bed are lower than reference values, for example, the processor 1 decreases the air flow rate of the air to be sent to the air blowing sheet 10 by the air blowing apparatus 20.

As illustrated in FIG. 2, the temperature-humidity information measurement unit 60 may include a collecting section 61, a first flow path 62a and a second flow path 62b, and a temperature-humidity sensor 63. The collecting section 61 is provided between the air mattress 40a and a user. In FIG. 2, the collecting section 61 is provided below the air blowing sheet 10. The first flow path 62a and the second flow path 62b are connected to the collecting section 61. The temperature-humidity sensor 63 is connected to the first flow path 62a and the second flow path 62b, and measures a temperature and a humidity of the air collected in the collecting section 61. The collecting section 61 may have a durometer hardness equal to or less than A75 and equal to or more than A5, for example. The thickness of the collecting section 61 may be equal to or more than 1 mm and equal to or less than 5 mm. Due to a purpose of collecting the gas (air) between the mattress 40 and a person (user) lying on the mattress 40, the collecting section 61 preferably has a size smaller than the size of the body of the user. Preferably, the length in each of a first direction D1 and a second direction D2 is equal to or less than 15 cm, and more preferably, the length in each of the first direction D1 and the second direction D2 is equal to or less than 10 cm. The smaller the length is, the more preferable it is, and the length in each of the first direction D1 and the second direction D2 may be equal to or more than 1 cm. The collecting section 61 and the first flow path 62a and the second flow path 62b are preferably made of flexible materials so that burden on the user can be reduced. The temperature-humidity information measurement unit may have only one collecting section, but it is also possible to arrange multiple collecting sections in a matrix pattern on the mattress or the air blowing sheet and measure the temperature and humidity at multiple locations. This configuration allows for the detection of localized humidity buildup, and the air flow rate may be controlled based on the results.

The temperature-humidity information measurement unit 60 may include a chamber 64. The air sent to the temperature-humidity sensor 63 is stored in the chamber 64. The temperature-humidity sensor 63 is provided inside the chamber 64.

The bed 200 according to the embodiment may include the temperature-humidity information measurement unit 60 together with the temperature-humidity information acquisition unit, but the temperature-humidity information measurement unit 60 may be provided independent of the bed 200 according to the embodiment.

The body weight information acquisition unit included in the control apparatus 100 in the bed 200 acquires body weight information measured by a body weight measurement unit 50. The body weight measurement unit 50 is provided below the air blowing sheet 10. The body weight measurement unit 50 is provided below the mattress 40. The bed 200 includes bed base 41. The mattress 40 is placed on the bed base 41. The body weight measurement unit 50 is provided between the bed base 41 and the mattress 40.

The air blowing apparatus 20 blows the air into the air blowing sheet 10. As the air, the air in the room is supplied and used.

The sinking amount to the mattress 40 by a user having a heavy body weight is more than the sinking amount to the mattress 40 and the diffusion layer 12 by a user having a light body weight. In a case where the air flow rate in the user having a heavy body weight is set as same as the air flow rate in the user having a light body weight, the circulation of the air is insufficient. In the embodiment, the control apparatus 100 adjusts the amount of air to be blown to the air blowing sheet 10 based on a value detected by the body weight information acquisition unit. Alternatively, in the mattress 40 in which a body weight is estimated and the internal pressure is adjusted, the control apparatus 100 acquires information by measuring a body weight of the user, and adjusts the amount of air to be blown to the air blowing sheet 10. For example, the processor 1 controls the air blowing apparatus 20 to make the air flow rate to the air blowing sheet 10 in the user having a heavy body weight more than the air flow rate thereto in the user having a light body weight. The processor 1 controls the air blowing apparatus 20 to make the air flow rate to the air blowing sheet 10 in the user having a light body weight less than the air flow rate thereto in the user having a heavy body weight. With the embodiment, it is possible to provide the bed 200 in which suitable control is possible.

The bed 200 according to the embodiment may include the body weight measurement unit 50 together with the control apparatus 100 including the body weight information acquisition unit, but the body weight measurement unit 50 may be provided independent of the bed 200 according to the embodiment.

As has already been described, the diffusion layer 12 is provided inside the cover 11. The air blowing sheet 10 includes the diffusion layer 12, so that the air is blown from the air blowing port 16 so as to spread over inside the entire air blowing sheet, thereby making it possible to prevent a rise in the temperature-humidity inside the air blowing sheet 10 and between the user and the air blowing sheet 10, and secure the better air permeability.

In FIG. 2, a direction from the head to the feet of the user is set as a Y-axis direction. One direction perpendicular to the Y axis direction is set as an X axis direction. A direction perpendicular to the X axis direction and the Y axis direction is set as a Z axis direction. A direction from the mattress 40 to the air blowing sheet 10 is along the Z axis direction, for example. A left-and-right direction of the user corresponds to the X axis direction, for example.

The bed 200 may further include the air blowing port 16, an air blowing tube 17, and the air-exhaust port 18. The air blowing port 16 may be provided to the air blowing sheet 10 at a foot side. The air-exhaust port 18 may be provided to the air blowing sheet 10 at a head side. The air to be blown by the air blowing apparatus 20 is blown to the air blowing sheet 10 via the air blowing tube 17 and the air blowing port 16. The air blown into the air blowing sheet 10 is discharged from the air-exhaust port 18.

As illustrated in FIG. 2, the air blowing apparatus 20 may be provided at the foot side. Alternatively, the air blowing apparatus 20 may be provided at the head side. The air blowing apparatus 20 may be a blower, for example. When the air blowing port 16 is provided at the foot side, the air blowing apparatus 20 may be provided at the foot side as illustrated in FIG. 2, or the air blowing apparatus 20 may be provided at the head side, and the air from the air blowing apparatus 20 may be blown to the air blowing port 16 that is provided at foot side, via the air blowing tube 17.

As illustrated in FIG. 2, the body weight measurement unit 50 may include upper frames 51, lower frames 52, lifting frames 53, and load cells 54. The upper frames 51 are provided below the air blowing sheet 10. The lower frames 52 are provided below the upper frames 51. The lifting frames 53 are connected to the lower frame 52 and the upper frame 51. The load cell 54 is provided between the lower frame 52 and the lifting frame 53, for example.

The load cell 54 includes a strain gauge in which a resistance value changes due to a strain caused by a load. The load cell 54 detects a load value (body weight) based on a change in voltage due to a change in the resistance value. The position at which the load cell 54 is installed is not specially limited as long as a load can be detected. For example, the load cell 54 may be provided to between the lower frame 52 and the lifting frame 53, provided to any of the upper frame 51, the lower frame 52, the lifting frame and the like, or provided to at least a plurality of such locations.

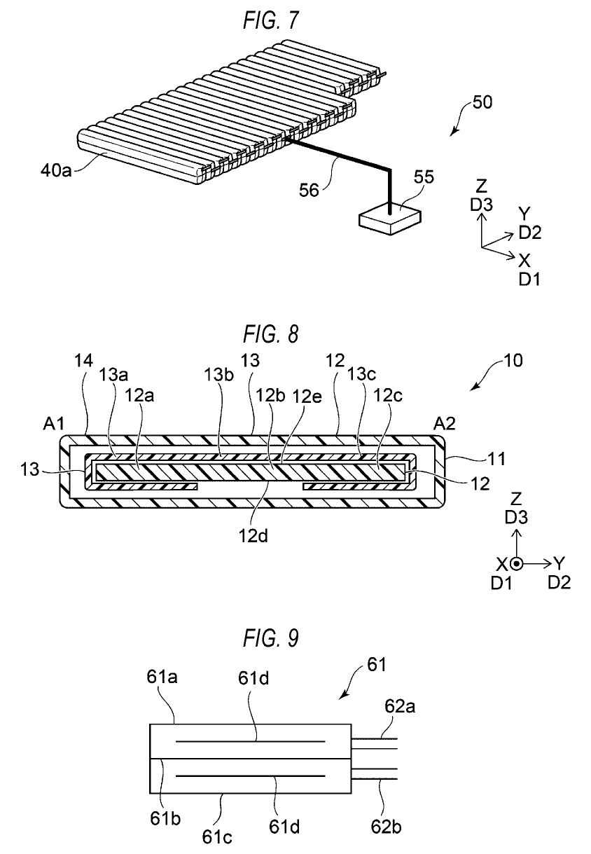

FIG. 7 is a schematic perspective view illustrating an example of a part of the bed according to the embodiment.

As illustrated in FIG. 7, the bed 200 may include the air mattress 40a. The air mattress 40a is a mattress with which the air is filled. The body weight measurement unit 50 may include a pressure measurement unit 55. The pressure measurement unit 55 measures an internal pressure of the air mattress 40a. The body weight measurement unit 50 may include wiring 56. The pressure measurement unit 55 is connected to the air mattress 40a via the wiring 56. For example, in a case where the volumetric capacity of the air mattress 40a is constant, the internal pressure differs depending on the body weight. The internal pressure in a user having a heavy body weight is higher than the internal pressure in a user having a light body weight. For example, a body weight may be grasped by measuring the internal pressure with respect to the body weight in advance. The body weight measurement unit 50 measures a body weight by the pressure measurement unit 55.

The body weight measurement unit 50 may include an air-exhaust time measurement unit. The air-exhaust time measurement unit measures air-exhaust time of the air in the air mattress 40a. For example, in a case where the volumetric capacity of the air mattress 40a is constant and the size of the air blowing tube 17 through which the air is blown to the air blowing sheet 10 is also constant (not too large), the air-exhaust time differs depending on the body weight. The air-exhaust time in a user having a heavy body weight is longer than the air-exhaust time in a user having a light body weight. A body weight may be grasped by measuring the air-exhaust time with respect to the body weight in advance. The body weight measurement unit 50 measures a body weight by an air-exhaust time measurement unit. The body weight measurement unit 50 may measure a body weight of the user from a changing amount of the air filled with the air mattress 40a.

The heart rate information acquisition unit included in the control apparatus 100 in the bed 200 acquires heart rate information measured by a heart rate measurement unit 70. The heart rate measurement unit 70 is provided on the bed base 41. The bed base 41 are provided below the air mattress 40a. The heart rate measurement unit 70 is provided between the air mattress 40a and the bed base 41. The heart rate measurement unit 70 measures heart rate of the user. The processor 1 receives information from the heart rate information acquisition unit, and controls the air flow rate of the air blowing apparatus 20. The heart rate measurement unit 70 may include a vibration detector 70a. The vibration detector 70a detects vibration in the heart rate of the user.

When the user is present on the mattress 40, the vibration detector 70a in the heart rate measurement unit 70 detects body movement (vibration) of the user via the mattress 40. The heart rate (heart rate within a predetermined time) of the user is then detected based on the detected vibration. The heart rate measurement unit 70 is preferably configured to be a sheet shape so as to have a thin thickness. Accordingly, even if the heart rate measurement unit 70 is placed between the bed 200 and the mattress 40, the heart rate measurement unit 70 can be used without causing discomfort to the user.

The heart rate measurement unit 70 may detect heart rate based on the body movement as mentioned above, may detect heart rate using a sound sensor, or may detect the body movement of the user with an infrared sensor and the like.

In a case where the heart rate in use time is higher than the heart rate in normal time in the user, as compared with a case where the heart rate in use time is lower than the heart rate in normal time, the body temperature of the user in use time is higher than the body temperature of the user in normal time. In the embodiment, the heart rate information acquisition unit is present, so that it is possible to appropriately adjust the amount of air to be sent to the air blowing sheet 10. For example, for the user whose heart rate in use time is higher than the heart rate in normal time, the processor 1 increases the air flow rate of the air to be sent to the air blowing sheet 10 by the air blowing apparatus 20. On the other hand, for the user whose heart rate in use time is lower than the heart rate in normal time, the processor 1 decreases the air flow rate of the air to be sent to the air blowing sheet 10 by the air blowing apparatus 20.

The bed 200 according to the embodiment may include the heart rate measurement unit 70 together with the heart rate information acquisition unit, but the heart rate measurement unit 70 may be provided independent of the bed 200 according to the embodiment.

The sleep depth information acquisition unit included in the control apparatus 100 in the bed 200 acquires sleep depth information measured by a sleep depth measurement unit 71. The sleep depth measurement unit 71 is provided on the bed base 41. The sleep depth measurement unit 71 is provided between the air mattress 40a and the bed base 41. The sleep depth measurement unit 71 measures a depth of sleep of the user.

The sleep depth measurement unit 71 detects heart rate of the user, outputs a heart rate included in the heart rate calculation time from the detected heart rate, and calculates a heart rate variation coefficient using an average value and a standard deviation of the heart rate included in a variation coefficient calculation section. By comparing the heart rate variation coefficient with an average heart rate variation coefficient that is an average value of the heart rate variation coefficient from bedtime to wakeup, the sleep depth of the user (whether the sleeping state is REM sleep or non-REM sleep) is determined. The sleep depth measurement unit 71 is preferably configured to be a sheet shape so as to have a thin thickness, similar to the heart rate measurement unit 70.

The processor 1 receives information from the sleep depth information acquisition unit, and controls the air flow rate of the air blowing apparatus 20. The sleep depth measurement unit 71 may include a body temperature detector 71a.

During sleep, heat radiates from the skin in order to decrease the core body temperature. Accordingly, the temperature in the skin increases, and the core body temperature becomes low. In the embodiment, the sleep depth measurement unit 71 is present, so that the amount of air to be sent to the air blowing sheet 10 is adjusted. For example, during sleep, the processor 1 decreases the air flow rate of the air to be sent to the air blowing sheet 10 by the air blowing apparatus 20.

The bed 200 according to the embodiment may include the sleep depth measurement unit 71 together with the sleep depth information acquisition unit, but the sleep depth measurement unit 71 may be provided independent of the bed 200 according to the embodiment.

The airflow rate of the air blowing apparatus may also be controlled using the machine learning model based on an index indicative of user comfort, which is determined from information indicative of at least one of the user’s feedback, the user's heart rate and the depth of sleep. The model controls the airflow rate to bring the index within a predetermined target range. For instance, the control apparatus 100 may increase the airflow rate when the user is falling asleep to promote a decrease in core body temperature, stop the airflow or decrease the airflow rate when the user is in deep sleep, and gradually restart the airflow or increase the airflow rate toward wakeup

The illumination information acquisition unit included in the control apparatus 100 in the bed 200 acquires illumination information measured by a light detector 80. The light detector 80 detects an illumination in the room and whether lights-out is made. The processor 1 receives information from the light detector 80, and controls the airflow rate of the air blowing apparatus 20.

The air blowing apparatus 20 generates a sound when sending the air. For example, in a case where the airflow rate of the air by the air blowing apparatus 20 is much, the sound by the air blowing apparatus 20 is loud. When the light is turned out in the room, it is preferable not to prevent sleeping of the user. In the embodiment, the illumination information acquisition unit is present, so that it is possible to adjust the amount of air to be sent to the air blowing sheet 10. For example, in a case where the illumination in the room becomes low or the light is turned out, the processor 1 decreases the airflow rate of the air to be sent to the air blowing sheet 10 by the air blowing apparatus 20.

The bed 200 according to the embodiment may include the light detector 80 together with the illumination information acquisition unit, but the light detector 80 may be provided independent of the bed 200 according to the embodiment.

FIG. 8 is a schematic cross-sectional view illustrating an example of a part of the bed according to the embodiment.

As illustrated in FIG. 8, in the bed 200, the air blowing sheet 10 may include a sheet member 13. The sheet member 13 is provided inside the cover 11. The diffusion layer 12 is provided inside the sheet member 13.

The sheet member 13 includes a sheet section first surface 13a, a sheet section second surface 13b, and a sheet section third surface 13c. The sheet section second surface 13b is present between the sheet section first surface 13a and the sheet section third surface 13c. The sheet section first surface 13a corresponds to from the head part to the back of the user. The sheet section second surface 13b corresponds to buttocks of the user. The sheet section third surface 13c corresponds to from the upper leg part to the foot part of the user.

In the sheet section first surface 13a and the sheet section third surface 13c, the slipperiness along the second direction D2 intersecting with the first direction D1 from the sheet section first surface 13a to the sheet section third surface 13c is higher than the slipperiness along the first direction D1. In the sheet section second surface 13b, the slipperiness along the first direction D1 is higher than the slipperiness along the second direction D2. The sheet member 13 includes polyester, for example. The slipperiness can be variable in a direction in which polyester fabric is knitted, for example.

The first direction D1 may be the X axis direction, for example. The second direction D2 may be the Y axis direction, for example.

When a user lies on the bed 200, the body weight of the user is applied the most to the sheet section second surface 13b corresponding to the buttocks. The sheet section second surface 13b having low slipperiness along the second direction D2 can prevent the cover 11 from shifting along the second direction D2. The prevention characteristics of shift is further effective when the air blowing sheet 10 including the sheet member 13 is used in the bed 200 in which the bed base 41 is raised.

The diffusion layer 12 includes a first portion 12a, a second portion 12b, and a third portion 12c. The diffusion layer 12 includes a diffusion first surface 12d and a diffusion second surface 12e. The second portion 12b is present between the first portion 12a and the third portion 12c. The sheet section first surface 13a is present on the first portion 12a. The sheet section second surface 13b is present on the second portion 12b. The sheet section third surface 13c is present on the third portion 12c. The second portion 12b includes a region that is not covered with the sheet member 13, on the diffusion first surface 12d. The diffusion first surface 12d is present between the diffusion second surface 12e and the cover 11. The diffusion second surface 12e is present between the diffusion first surface 12d and the cover 11.

In the embodiment, the air permeability of the diffusion layer 12 in conformity with JIS K 6400-7: 2012 B may be equal to or more than 200 ml/(cm²∙sec). The diffusion layer 12 has excellent air permeability in a case where the air permeability is 200 ml/(cm²∙sec).

The 40% hardness of the diffusion layer 12 in conformity with JIS K 6400-2 A may be equal to or more than 50 N/314cm² and equal to or less than 300 N/314cm². When equal to or more than 50 N/314cm², the diffusion layer 12 is hard to be compressed and the air is easy to ventilate the diffusion layer 12. When the 40% hardness of the diffusion layer 12 is equal to or less than 300 N/314cm², discomfort is hard to be generated in the user.

The 50% compressive residual strain of the diffusion layer 12 in conformity with JIS K 6400-4 is equal to or less than 10%. When equal to or less than 10%, the diffusion layer 12 has a small deformation amount. As a result, the air is easy to ventilate the diffusion layer 12.

The repeated compressive residual strain of the diffusion layer 12 in conformity with JIS K 6400-4 is equal to or less than 10%. When equal to or less than 10%, the diffusion layer 12 has a small deformation amount. As a result, the air is easy to ventilate the diffusion layer 12.

In the bed 200, the diffusion layer 12 may have the value within the abovementioned range of each of the air permeability, the 40% hardness, the 50% compressive residual strain, and the repeated compressive residual strain. Accordingly, the diffusion layer 12 has excellent air permeability. Even when the user lies on the bed 200 to compress the cover 11, the air can move in the location and in the surrounding of the location. The bed 200 can attain the suitable control.

The water resistance of the cover 11 in conformity with JIS L 1092 B may be equal to or more than 4 kPa. The moisture permeability of the cover 11 in conformity with JIS L 1099 A1 may be equal to or more than 55 g/(cm²∙hour).

FIG. 9 is a schematic side view illustrating an example of a part of the bed according to the embodiment.

As illustrated in FIG. 9, in the temperature-humidity information measurement unit 60, the collecting section 61 may have a bag shaped structure including an upper film 61a, an intermediate film 61b, and a lower film 61c. The upper film 61a and the lower film 61c each include a material having air permeability. The intermediate film 61b includes a material having no air permeability. The temperature-humidity information measurement unit 60 may include a pump. In the collecting section 61, the air in a space formed by the upper film 61a and the intermediate film 61b is sent to the first flow path 62a, the temperature-humidity sensor 63, the pump, and the second flow path 62b. The air in a space formed by the lower film 61c and the intermediate film 61b is returned via the second flow path 62b. The air circulates via the collecting section61, the first flow path 62a, the second flow path 62b, and the chamber 64.

The collecting section 61 includes the upper film 61a and the lower film 61c, which have air permeability, so that it is possible to prevent the collecting section 61 from being blocked between the outer side and the inner side. It is possible to measure the temperature and humidity with high reliability. The collecting section 61 may have a bag shaped structure in which a polyurethane film, a polyurethane film having a surface provided with a nylon cloth, a polyethylene film, a thermoplastic resin such as a vinyl chloride film, or a rubber sheet is welded or bonded. The collecting section 61 may include, between the upper film 61a and the intermediate film 61b, a blockage prevention layer 61d that prevents blockage of the first flow path 62a. The collecting section 61 may include, between the intermediate film 61b and the lower film 61c, a blockage prevention layer 61d that prevents blockage of the second flow path 62b. The blockage prevention layers 61d are provided along the upper film 61a, the intermediate film 61b, and the lower film 61c. The blockage prevention layer 61d is sandwiched between the upper film 61a and the intermediate film 61b, or between the intermediate film 61b and the lower film 61c. The blockage prevention layer 61d may be an urethane foam having air permeability. The blockage prevention layer 61d may be a three-dimensional stereoscopic knitted structure having air permeability. The blockage prevention layer 61d provided between the upper film 61a and the intermediate film 61b can prevent suction blockage of the air from the first flow path 62a. The blockage prevention layer 61d provided between the intermediate film 61b and the lower film 61c can prevent discharge blockage of the air from the second flow path 62b.

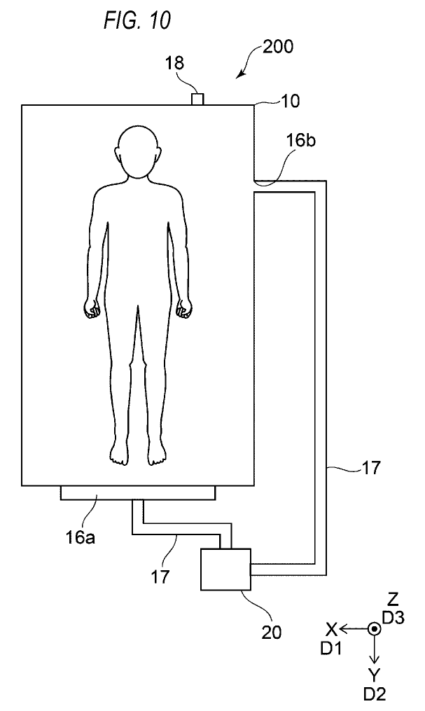

FIG. 10 is a schematic plan view illustrating an example of a part of the bed according to the embodiment.

As illustrated in FIG. 10, in the bed 200, the air blowing sheet 10 includes a first air blowing port 16a and a second air blowing port 16b. The number of the air blowing ports 16 (the first air blowing port 16a, the second air blowing port 16b) is not limited. The first air blowing port 16a may be provided at the foot side, for example. The second air blowing port 16b may be provided at the head side, for example. The air is blown to the air blowing sheet 10 from the air blowing apparatus 20 via the air blowing tube 17 and the first air blowing port 16a. The air is blown to the air blowing sheet 10 from the air blowing apparatus 20 via the air blowing tube 17 and the second air blowing port 16b. The air-exhaust port 18 may be provided at the head side.

The length of the first air blowing port 16a in the first direction D1 is wide in the first direction D1. Accordingly, even if the feet of the user are present at any locations in the first direction D1, the first air blowing port 16a is not entirely blocked, and the air is blown into the air blowing sheet 10. As mentioned in the foregoing, the diffusion layer 12 is provided inside the cover 11, so that the air blown from the air blowing port 16 is blown so as to spread over inside the entire air blowing sheet 10. This can secure the better air permeability.

The first air blowing port 16a may be provided at the head side of the user. In this case, the air-exhaust port 18 is provided at the foot side of the user.

The first air blowing port 16a may include a material having flexibility or non-flexibility.

The cover 11 may be provided on the mattress 40. Meanwhile, the mattress 40 may be provided inside the cover 11. The diffusion layer 12 may be provided on the mattress 40. The mattress 40 may include urethane.

The control apparatus 100 and the bed 200 according to the embodiment are used by being attached to medical or care beds, for example. The bed 200 is provided with the mattress 40 or the air mattress 40a. The cover 11 of the bed 200 is provided on the mattress 40 or the air mattress 40a, for example. A user lies on the mattress 40 or the air mattress 40a. The bed 200 is used in a care facility and home of the user, in addition to a medical institution such as a hospital. The user of the mattress 40 or the air mattress 40a is, for example, a patient or a care recipient.

The control apparatus 100 and the bed 200 according to the embodiment may be used for bedsore prevention, for example. The control apparatus 100 and the bed 200 may be used in the microclimate management.

With the embodiment of the present disclosure, it is possible to provide a control apparatus and a bed in which suitable control is possible.

The present disclosure includes the following aspects.

### Appendix 1

A control apparatus for controlling an airflow rate of an air blowing apparatus configured to send air into an air blowing sheet including a cover and a diffusion layer, the cover having waterproofness and moisture permeability, the diffusion layer being provided inside the cover and having air permeability, the control apparatus including:

a processor configured to control the airflow rate of the air blowing apparatus based on information on a temperature and a humidity between a user and the air blowing sheet.

### Appendix 2

The control apparatus according to appendix 1, in which the processor is configured to control the airflow rate of the air blowing apparatus based on information on a state of strain with respect to the diffusion layer by the user.

### Appendix 3

The control apparatus according to appendix 1 or 2, in which

the air blowing sheet includes an air blowing port into which air is blown from the air blowing apparatus, and an air-exhaust port from which the blown air is discharged from the air blowing sheet, and

the processor is configured to control the airflow rate of the air blowing apparatus based on information on an amount of air blown into the air blowing port and an amount of air discharged from the air-exhaust port.

### Appendix 4

The control apparatus according to any one of appendices 1 to 3, in which the processor is configured to control the airflow rate of the air blowing apparatus based on body weight information of the user.

### Appendix 5

The control apparatus according to any one of appendices 1 to 4, in which the processor is configured to control the airflow rate of the air blowing apparatus based on heart rate information of the user.

### Appendix 6

The control apparatus according to any one of appendices 1 to 5, in which the processor is configured to control the airflow rate of the air blowing apparatus based on information on a depth of sleep of the user.

### Appendix 7

The control apparatus according to any one of appendices 1 to 6, in which the processor is configured to control the airflow rate of the air blowing apparatus based on information on an illumination in a room where the user is present.

### Appendix 8

### A bed including:

an air blowing sheet including a cover having waterproofness and moisture permeability, and a diffusion layer provided inside the cover and having air permeability;

a mattress that is provided below the air blowing sheet;

a control apparatus including a processor configured to control an airflow rate; and

an air blowing apparatus configured to send air having an airflow rate controlled by the control apparatus into the air blowing sheet, in which

the control apparatus is configured to control the airflow rate of the air blowing apparatus based on information on a temperature and a humidity between a user and the air blowing sheet.

### Appendix 9

The bed according to appendix 8, in which the air permeability of the diffusion layer in conformity with JIS K 6400-7: 2012 B is equal to or more than 200 ml/(cm²∙sec).

### Appendix 10

The bed according to appendix 8 or 9, in which a 40% hardness of the diffusion layer in conformity with JIS K 6400-2 A is equal to or more than 50 N/314cm² and equal to or less than 300 N/314cm².

### Appendix 11

The bed according to any one of appendices 8 to 10, in which 50% compressive residual strain of the diffusion layer in conformity with JIS K 6400-4 is equal to or less than 10%.

### Appendix 12

The bed according to any one of appendices 8 to 11, in which repeated compressive residual strain of the diffusion layer in conformity with JIS K 6400-4 is equal to or less than 10%.

### Appendix 13

The bed according to any one of appendices 8 to 12, further including:

a temperature-humidity information measurement unit configured to measure the temperature and the humidity, in which

the temperature-humidity information measurement unit includes

a collecting section provided between the mattress and the user,

a first flow path and a second flow path connected to the collecting section, and

a temperature-humidity sensor connected to the first flow path and the second flow path, the temperature-humidity sensor being configured to measure the temperature and the humidity of the air collected by the collecting section.

### Appendix 14

The bed according to appendix 13, in which

the temperature-humidity information measurement unit further includes a chamber in which the air sent to the temperature-humidity sensor is stored, and

the temperature-humidity sensor is provided inside the chamber.

### Appendix 15

The bed according to appendix 13 or 14, in which the collecting section has a bag shaped structure including an upper film, an intermediate film, and a lower film.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A control apparatus for controlling an airflow rate of an air blowing apparatus configured to send air into an air blowing sheet including a cover and a diffusion layer, the cover having waterproofness and moisture permeability, the diffusion layer being provided inside the cover and having air permeability, the control apparatus comprising:
a processor configured to control the airflow rate of the air blowing apparatus based on information on a temperature and a humidity between a user and the air blowing sheet.

2. The control apparatus according to claim 1, wherein the processor is configured to control the airflow rate of the air blowing apparatus based on information on a state of strain with respect to the diffusion layer by the user.

3. The control apparatus according to claim 1, wherein
the air blowing sheet includes an air blowing port into which air is blown from the air blowing apparatus, and an air-exhaust port from which the blown air is discharged from the air blowing sheet, and
the processor is configured to control the airflow rate of the air blowing apparatus based on information on an amount of air blown into the air blowing port and an amount of air discharged from the air-exhaust port.

4. The control apparatus according to claim 1, wherein the processor is configured to control the airflow rate of the air blowing apparatus based on body weight information of the user.

5. The control apparatus according to claim 1, wherein the processor is configured to control the airflow rate of the air blowing apparatus based on heart rate information of the user.

6. The control apparatus according to claim 1, wherein the processor is configured to control the airflow rate of the air blowing apparatus based on information on a depth of sleep of the user.

7. The control apparatus according to claim 1, wherein the processor is configured to control the airflow rate of the air blowing apparatus based on information on an illumination in a room where the user is present.

8. A bed comprising:
an air blowing sheet including a cover having waterproofness and moisture permeability, and a diffusion layer provided inside the cover and having air permeability;
a mattress that is provided below the air blowing sheet;
a control apparatus including a processor configured to control an airflow rate; and
an air blowing apparatus configured to send air having an airflow rate controlled by the control apparatus into the air blowing sheet, wherein
the control apparatus is configured to control the airflow rate of the air blowing apparatus based on information on a temperature and a humidity between a user and the air blowing sheet.

9. The bed according to claim 8, wherein the air permeability of the diffusion layer in conformity with JIS K 6400-7: 2012 B is equal to or more than 200 ml/(cm²∙sec).

10. The bed according to claim 8, wherein a 40% hardness of the diffusion layer in conformity with JIS K 6400-2 A is equal to or more than 50 N/314 cm² and equal to or less than 300 N/314 cm².

11. The bed according to claim 8, wherein 50% compressive residual strain of the diffusion layer in conformity with JIS K 6400-4 is equal to or less than 10%.

12. The bed according to claim 8, wherein repeated compressive residual strain of the diffusion layer in conformity with JIS K 6400-4 is equal to or less than 10%.

13. The bed according to claim 8, further comprising:
a temperature-humidity information measurement unit configured to measure the temperature and the humidity, wherein
the temperature-humidity information measurement unit includes
a collecting section provided between the mattress and the user,
a first flow path and a second flow path connected to the collecting section, and
a temperature-humidity sensor connected to the first flow path and the second flow path, the temperature-humidity sensor being configured to measure the temperature and the humidity of the air collected by the collecting section.

14. The bed according to claim 13, wherein
the temperature-humidity information measurement unit further includes a chamber in which the air sent to the temperature-humidity sensor is stored, and
the temperature-humidity sensor is provided inside the chamber.

15. The bed according to claim 13, wherein the collecting section has a bag shaped structure including an upper film, an intermediate film, and a lower film.
